(19) United States
(12) Patent Application Publication
(10) Pub. No.: US 2013/0243178 A1
(43) Pub. Date: Sep. 19, 2013

(54) METHOD FOR IMPLEMENTING A TELEPHONE COMMUNICATION WITH A TELEPHONE COMMUNICATION SUBSCRIBER

(71) Applicants: Vladimir Vitalievich Miroshnichenko, Ljubertsi (RU); Vitaly Evgenievich Pilkin, Moscow (RU)

(72) Inventors: Vladimir Vitalievich Miroshnichenko, Ljubertsi (RU); Vitaly Evgenievich Pilkin, Moscow (RU)

(21) Appl. No.: 13/882,784

(22) PCT Filed: Aug. 30, 2011
(86) PCT No.: PCT/RU2011/000660

§ 371 Date: May 1, 2013

(30) Foreign Application Priority Data
Dec. 6, 2010 (RU) 2010149510

(51) Int. Cl. H04M 3/44

(52) U.S. Cl. CPC H04M 3/44
USPC 379/216.01

(57) ABSTRACT

A method is herein proposed for implementing a telephone communication with a telephone communication subscriber. The method allows extending the variance of code selection corresponding to telephone numbers of the subscribers and optimizing the communication between the subscribers by means of the use of correspondence codes and information codes. The proposed method contemplates: (a) in order to implement a telephone communication with a subscriber and/or with a telephone communication device, a correspondence code is used which does not contain any digits or does not only contain digits, and/or (b) in order to implement a telephone communication with a telephone communication subscriber or with a subscriber telephone communication device, an information code is used, on the basis of which communication tools, with or without the use of the Internet, perform a search for contact data of a called subscriber or a subscriber telephone communication device.

### CROSS-REFERENCE TO RELATED APPLICATIONS

This application is a U.S. national stage application of a PCT application PCT/RU2011/000660 filed on 30 Aug. 2011, published as WO 2012/078074, whose disclosure is incorporated herein in its entirety by reference, which PCT application claims priority of a Russian Federation application RU2010149510 filed on 6 Dec. 2010.

### FIELD OF THE INVENTION

This invention relates to the electronic engineering and to the method of telephone communication with a telephone communication subscriber, in particular.

### BACKGROUND OF THE INVENTION

There are known analog and digital telephone systems providing for the data transmission via communication channels.

There are known analog and digital telephone communication wherein a telephone call to a telephone communication subscriber is originated via dialing of a telephone number consisting of digits.

Sometimes in various countries mnemonic or conventional substitution of some digits of the telephone number (consisting in reality of digits only) for letters for better fixing in a human's mind was used and is used.

Internet telephone system being a technology allowing using the Internet or other network for the purposes of transmission of telephone signals is also known.

The company called Skype, a provider of Internet telephony services, is known. Login being a unique Skype user's name is used instead of a telephone number. The first symbol of a login is a Latin letter, login shall contain 6-32 symbols and include Latin letters and Arabic numerals only, provided that login should not include spaces nor any special symbols.

There is the Russian Federation patent No 22117406, (page 3, left column, line 63—right column, line 32) in which a telephone communication subscriber “A” when calling to a subscriber “B”, uses a short number consisting of digits, depending on the subscriber “A”, on having received which signal telephone operator will connect the subscriber “A” with a telephone number of the subscriber “B”, to which the said short telephone number is attached.

There is the Russian Federation patent No 22332803 (page 8, line 51—page 9, line 5) in which a telephone communication subscriber “A” when calling to a subscriber “B” uses an identification number of the subscriber “B”, on having received which signal telephone operator connects the subscriber “A” with a telephone number of the subscriber “B”, to which telephone number (numbers) the said identification number is attached. A combination of numerals is used as the said identification number in the above patent.

There is a French patent application FR2856542 (page 1, lines 25-30), in which (according to the method of the personalized telephone signal processing) a telephone communication subscriber when calling to another subscriber uses a short number consisting of digits, depending on the calling subscriber, on having received which signal telephone operator connects the calling subscriber with a telephone number of the call receiving subscriber, to which the said short telephone number is attached.

The Russian Federation patent No 22117406, the Russian Federation patent No 22332803 and a patent application FR2856542 are the most closely technical solutions in respect to the claimed invention. A short number in the Russian Federation patent No 22117406, an identification number in the Russian Federation patent No 22332803 or a short number in a patent application FR2856542 are the correspondence codes or codes which correspond to the telephone call receiving subscriber's telephone number.

Drawbacks of the Russian Federation patent No 22117406, the Russian Federation patent No 22332803 and a patent application FR2856542 lie in the following: a combination of numerals is used as the correspondence code only without any other possibilities concerning the choice of correspondence codes (for example, using letters or combination of letters and numerals, or photo-images, multimedia files etc.).

### DESCRIPTION OF THE INVENTION

This invention is aimed at the extension of variance in the selection of codes which correspond to telephone numbers of called telephone communication subscribers, as well as at the optimization of communication between telephone communication subscribers via the use of correspondence codes and information codes.

The following terms and definitions were used for the purposes of correct understanding and explanation of concepts used in connection with the claimed invention:

Telecommunication means any emissions, transmission and/or receipt of characters, signals, voice information, written text, images, sounds, messages of every nature, via radio system, wire-, optical and other electromagnetic systems.

Communication means mean technical and software means to be used for the purposes of formation, receipt, processing, storage, transmission, delivery of telephone messages of telecommunication, as well as other technical and software means to be used in connection with provision of telephone communication services, control of functioning telephone communication networks, herewith communication means are implemented with or without a Web interface.

Auxiliary parameter of a digit means parameter of a digit not related to the meaning of such digit (the meaning is a basic parameter of a digit); for example, digit's color or color of a part of a digit, type of a digit or digit's size, digit's design, digit in 3D, or digit is blinking (or is not blinking), digit is moving (or is not moving), changing size of a digit (not changing size) etc.

Auxiliary parameter of a letter means parameter of a letter not related to the meaning of such letter (the meaning is a basic parameter of a letter); for example, letter's color or color of a part of a letter, type of a letter or letter's size, letter's design, letter in 3D, or letter is blinking (or is not blinking), letter is moving (or is not moving), changing size of a letter (or not changing size) etc.

Auxiliary parameter of a character (being not a digit) means parameter of a character not related to the meaning of such character (the meaning is a basic parameter of a character); for example, character's color or color of a part of a character, type of a character or character's size, character's design, character in 3D, or character is blinking (or is not blinking), character is moving (or is not moving), changing size of a character (or not changing size) etc.

Auxiliary parameter of a hieroglyph means parameter of a hieroglyph not related to the meaning of such hieroglyph (the meaning is a basic parameter of a hieroglyph); for example, hieroglyph's color or color of a part of a hieroglyph, type of a hieroglyph or hieroglyph's size, hieroglyph's design, hieroglyph in 3D, or hieroglyph is blinking (or is not blinking), hieroglyph is moving (or is not moving), changing size of a hieroglyph (or not changing size) etc.

Auxiliary parameter of a symbol means parameter of a symbol not related to the meaning of such symbol (the meaning is a basic parameter of a symbol); for example, symbol's color or color of a part of a symbol, type of a symbol or symbol's size, symbol's design, symbol in 3D, or symbol is blinking (or is not blinking), symbol is moving (or is not moving), changing size of a symbol (or not changing size) etc.

The above technical result is achieved as follows:

A method for implementing a telephone communication with a telephone communication subscriber, wherein:

(1) On having received a code (hereinafter referred to as the “correspondence code”), transmitted (presented) to the communication means by a device equipped with a telephone communication (hereinafter the said device referred to as the “calling device”), communication means perform actions including the following steps: telephone call to a telephone communication subscriber (hereinafter referred to as the “call receiving subscriber”) via the call receiving subscriber's subscriber device, and/or data (message) transmission received by the communication means from the calling device to the call receiving subscriber's subscriber device, and/or data (message) transmission received by the communication means from the call receiving subscriber's subscriber device to the calling device, and/or transmission to the calling device of data (message) connected with the call receiving subscriber and/or with the call receiving subscriber's subscriber device, and/or transmission of data (message) connected with the user of the calling device and/or with the calling device to the call receiving subscriber's subscriber device, herewith the correspondence code is attached to:
(a) the call receiving subscriber's telephone number, herewith the correspondence code is other than the call receiving subscriber's telephone number; herewith one correspondence code or more than one dissimilar correspondence codes is/are attached to the call receiving subscriber's telephone number,

or
(b) a group of the call receiving subscriber's telephone numbers, herewith the correspondence code is other than the call receiving subscriber's telephone numbers, herewith one correspondence code or more than one dissimilar correspondence codes is/are attached to a group of the call receiving subscriber's telephone numbers,

or
(c) the call receiving subscriber, herewith at calling to receiving subscriber's telephone number by entering the correspondence code attached to the call receiving subscriber, such call is addressed to at least one telephone number of all telephone numbers attached to the call receiving subscriber, herewith the correspondence code is other than the call receiving subscriber's telephone numbers, herewith one correspondence code or more than one dissimilar correspondence codes is/are attached to the call receiving subscriber's telephone number,

or
(d) the call receiving subscriber as the call receiving subscriber's telephone number, herewith one correspondence code or more than one dissimilar correspondence codes is/are attached to the call receiving subscriber as a telephone number;
   herewith, as concern to sub-paragraphs [symbol] a [symbol] , [symbol] b [symbol] , [symbol] c [symbol] , [symbol] d [symbol] , the correspondence code is attached by communication means or via communication means or without using such communication means;

or

(2) On having received the correspondence code, transmitted (presented) to the communication means by the calling device, communication means perform actions including the following steps: telephone call to a group of telephone communication subscribers (such group is hereinafter referred to as the “group of call receiving subscribers”) via the subscriber device (devices) of the group of call receiving subscribers, and/or data (message) transmission received by the communication means from the calling device to the subscriber device (devices) of the group of call receiving subscribers, and/or data (message) transmission received by the communication means from subscriber device (devices) of the group of telephone communication subscribers to the calling device, and/or transmission to the calling device data (message) connected with the group of call receiving subscribers and/or with the subscriber device (devices) of the group of call receiving subscribers, and/or transmission of data (message) connected with the user of the calling device and/or with the calling device, to the subscriber device (devices) of the group of call receiving subscribers, herewith the correspondence code is attached to:
(a) the telephone number (numbers) of the group of call receiving subscribers, herewith the correspondence code is other than the telephone numbers of the group of call receiving subscribers,

and/or
(b) the subscribers within the group of the call receiving subscribers,

or
(c) the group of call receiving subscribers as the telephone number of the group of call receiving subscribers, herewith one correspondence code or more than one dissimilar correspondence codes is/are attached to the group of call receiving subscribers as a telephone number,
   herewith, as concern to sub-paragraphs [symbol] a [symbol] , [symbol] b [symbol] , [symbol] c [symbol] , the correspondence code is attached by communication means or via communication means or without using such communication means;

or

(3) On having received the correspondence code transmitted (presented) to the communication means by the calling device, communication means perform actions including the following steps: telephone call to the device equipped with telephone communication (such device is hereinafter referred to as the “call receiving device”); and/or data (message) transmission received by the communication means from the calling device to the call receiving device, and/or data (message) transmission received by the communication means from the call receiving device to the calling device; and/or transmission of data (message) connected with the call receiving device to the calling device; and/or transmission of data (message) connected with the user of the calling device and/or with the calling device to the call receiving device, herewith the correspondence code is attached to:
(a) the telephone number of the call receiving device, herewith the correspondence code is other than a telephone number of the call receiving device; herewith one correspondence code or more than one dissimilar correspondence codes is/are attached to the telephone number of the call receiving device,

or
(b) the call receiving device as a telephone number of the call receiving device, herewith one correspondence code or more than one dissimilar correspondence codes is/are attached to the call receiving device as a telephone number, herewith as concern to sub-paragraphs [symbol] a [symbol] , [symbol] b [symbol] , the correspondence code is attached by communication means or via communication means or without using such communication means;

or

(4) On having received the correspondence code transmitted (presented) to the communication means by the calling device, communication means perform actions including the following steps: telephone call to the group of devices equipped with a telephone communication (such group is hereinafter referred to as the “group of call receiving devices”), and/or data transmission received by the communication means from the calling device to the group of call receiving devices, and/or data (message) transmission received by the communication means from the group of call receiving devices to the calling device, and/or transmission of data (message) connected with the group of call receiving devices to the calling device, and/or transmission of data (message) connected with the user of the calling device and/or with the calling device to the group of call receiving devices, herewith the correspondence code is attached to:
(a) telephone number (numbers) of the group of call receiving devices, herewith the correspondence code is other than telephone numbers of the group of call receiving devices; herewith one correspondence code or more than one dissimilar correspondence codes is/are attached to the telephone numbers of the group of call receiving devices;

or
(b) the group of call receiving devices as a telephone number of the group of call receiving devices, herewith one correspondence code or more than one dissimilar correspondence codes is/are attached to the group of call receiving devices as a telephone number, herewith, as concern to sub-paragraphs [symbol] a [symbol] , [symbol] b [symbol] , the correspondence code is attached by communication means or via communication means or without using such communication means;

or

(5) when a code which does not correspond to any correspondence code nor to the telephone number (such code not corresponding to any correspondence code nor to the telephone number, is hereinafter referred to as the “information code”) is received from the calling telephone communication subscriber, communication means perform actions stipulated by the content (sense) of the said information code, or any part thereof, via own software and hardware and/or via software and hardware of at least one other device connected to the communication means, whether with or without the use of Internet, including the following steps:
(a) search of a telephone number (numbers) and/or a correspondence code (codes) of the telephone communication subscriber or device equipped with the telephone communication, or a telephone numbers and/or a correspondence codes of telephone communication subscribers or devices equipped with the telephone communication, and/or telephone number or telephone numbers and/or correspondence code or correspondence codes of the group of telephone communication subscribers or group of devices equipped with the telephone communication, and/or telephone numbers and/or correspondence codes of groups of telephone communication subscribers or groups of devices equipped with the telephone communication and transmission of data received as a result of the above search to the calling subscriber;

and/or
(b) search of an e-mail address (e-mail addresses) of the subscriber or subscribers or the group of telephone communication subscribers or groups of telephone communication subscribers, and/or a device (devices) equipped with the telephone communication, and/or the group of devices or groups of devices equipped with the telephone communication; and/or any third person (persons) and transmission of data received as a result of the above search to the calling subscriber;

and/or
(c) search of the place of location of the subscriber or subscribers or the group of telephone communication subscribers, and/or a device or group of devices equipped with the telephone communication, and/or any third person (persons), and transmission of data received as a result of the above search to the calling subscriber;

and/or
(d) search of the address or addresses of the subscriber or subscribers or the group of telephone communication subscribers or groups of telephone communication subscribers, and/or a device (devices) equipped with the telephone communication, and/or the group of devices or groups of devices equipped with the telephone communication, and/or any third person (persons) and transmission of data received as a result of the above search to the calling subscriber;

and/or
(e) search of information in the Internet using the information code and transmission of data received as a result of the above search to the calling subscriber;

and/or
(f) connecting the calling subscriber with the telephone communication subscriber or group of telephone communication subscribers or with a device or group of devices equipped with telephone communication or with any third person (persons) in consideration of data received as a result of the above search;

and/or
(g) transmission of data received from the telephone communication subscriber or group of telephone communication subscribers or from a device or group of devices equipped with telephone communication or from any third person (persons) to the calling subscriber in consideration of data received as a result of the above search;

herewith:

the correspondence code specified in sub-paragraphs [symbol] a [symbol] , [symbol] b [symbol] , [symbol] c [symbol] of paragraph (1), in sub-paragraphs [symbol] a [symbol] , [symbol] b [symbol] of paragraph (2), in sub-paragraph [symbol] a [symbol] of paragraph (3), in sub-paragraph [symbol] a [symbol] of paragraph (4): a) constantly or periodically or temporary consists of or constantly or periodically or temporary includes at least one letter (taken from the alphabet of any language), and/or at least one character (other than a numeral), and/or at least a single space, and/or at least one symbol, and/or at least one hieroglyph, and/or at least one word chosen from any language, and/or an expression (chosen from any speech language), and/or at least one picture, and/or image of geometric figure, and/or at least one geometric figure, and/or at least one digital image, and/or at least one voice message, and/or at least one voice command, and/or at least one animation, and/or at least one animated image, and/or at least one virtual object, and/or at least one virtual 3D object, and/or graphical image, and/or computer graphics, and/or at least one video, and/or at least one file icon, and/or at least one file label, and/or at least one computer program icon, and/or at least one computer program label, and/or at least one digital image, and/or information (data) in verbal, graphical, sound or combined form, and/or at least one virtual reality object, and/or at least one sound, and/or at least a combination of sounds, and/or at least an electronic program, and/or at least one multimedia file, and/or at least one photo, and/or at least one Internet-link, or b) constantly or periodically or temporary includes items mentioned in the above sub-paragraph “a” and one or more numerals, or c) constantly or periodically or temporary includes items mentioned in the above sub-paragraph “a” and one or more numerals, herewith at least one auxiliary parameter of at least one of the mentioned numerals are taken into account; or d) constantly or periodically or temporary includes items mentioned in the above sub-paragraph “a”, herewith the correspondence code constantly or periodically or temporary includes at least one numeral; or e) constantly or periodically or temporary includes items mentioned in the above sub-paragraph “a”, herewith the correspondence code constantly or periodically or temporary includes at least one numeral, herewith if the correspondence code includes at least one numeral, at least one auxiliary parameter of at least one of the mentioned numerals are taken into account, or f) constantly or periodically or temporary consists of or constantly or periodically or temporary includes one or more numerals, herewith at least one auxiliary parameter of at least one of the mentioned numerals are taken into account; or g) constantly or periodically or temporary consists of or constantly or periodically or temporary includes one or more numerals, herewith the correspondence code constantly or periodically or temporary includes items mentioned in the above sub-paragraph “a”, or h) constantly or periodically or temporary consists of or constantly or periodically or temporary includes one or more numerals, herewith the correspondence code temporary or periodically includes items mentioned in the above sub-paragraph “a”, herewith at least one auxiliary parameter of at least one of the mentioned numerals are taken into account; or i) temporary or periodically includes a numeral or numerals; or j) temporary or periodically includes a numeral or numerals, herewith if the correspondence code includes at least one numeral, so at least one auxiliary parameter of at least one of the mentioned numerals are taken into account;
the correspondence code specified in sub-paragraph “d” of paragraph (1), in sub-paragraph “c” of paragraph (2), in sub-paragraph “b” of paragraph (3), in sub-paragraph “b” of paragraph (4) to be used as a telephone number consists of or includes: a) at least one letter (taken from the alphabet of any language), and/or at least one character (other than a numeral), and/or at least a single space, and/or at least a symbol, and/or at least one hieroglyph, and/or at least one word chosen from any language, and/or a combination of words/an expression (chosen from any speech language), and/or at least one picture, and/or image of geometric figure, and/or computer graphics, and/or at least one digital image, and/or animation, and/or animated image, and/or at least one voice message, and/or at least one voice command; and/or at least one sound and/or at least a combination of sounds, and/or at least an electronic program, and/or at least one multimedia file, and/or one photo, and/or at least one Internet-link, or b) the items mentioned in sub-paragraph “a” in combination with at least one numeral.

If the correspondence code mentioned in paragraph (1), sub-paragraphs “a”, “b”, “c”, paragraph (2), sub-paragraphs “a” and “b”, paragraph (3), sub-paragraph “a”, paragraph (4), sub-paragraph “a”, includes at least one element, so at least one auxiliary parameter of at least one mentioned element may be constantly or temporary or periodically taken into account, herewith the said elements include a letter and/or a character other than a numeral, and/or a symbol, and/or a hieroglyph, and/or a geometric figure.

Information code may constantly or periodically or temporary consist of or include at least one numeral, and/or at least one letter (taken from the alphabet of any language), and/or at least one character (other than a numeral), and/or at least a single space, and/or at least a symbol, and/or at least one hieroglyph, and/or at least one word chosen from any language, and/or a combination of words/an expression (chosen from any speech language), and/or at least one picture, and/or image of geometric figure, and/or at least one geometric figure, and/or at least one voice message, and/or at least one voice command, and/or at least one animation, and/or at least one animated image, and/or at least one virtual object, and/or at least one 3D virtual object and/or graphics and/or computer graphics, and/or at least one video, and/or at least one file icon, and/or at least one file label, and/or at least one computer program icon, and/or at least one computer program label, and/or information (data) in verbal, graphical, sound or combined form; and/or at least one virtual reality object, and/or at least one sound, and/or at least a combination of sounds, and/or at least an electronic program, and/or at least one multimedia file, and/or at least one photo, and/or at least one Internet-link.

If information code includes at least one element, so at least one auxiliary parameter of at least one mentioned element may be constantly or temporary or periodically taken into account, herewith the said elements include a numeral, and/or a letter and/or a character other than a numeral, and/or a symbol, and/or a hieroglyph.

The correspondence code and information code may be entered into the device equipped with a telephone communication line and/or into the device connected to the device equipped with a telephone communication, in writing and/or in the form of a text, and/or by voice as might be applicable.

The correspondence code and information code may be entered into the device equipped with a telephone communication line and/or into the device connected to the device equipped with a telephone communication when dialing the telephone number, as might be applicable.

The correspondence code may include a regional code defining a region in which the call receiving subscriber or group of call receiving subscribers, or call receiving device equipped with a telephone communication, or the group of call receiving devices equipped with a telephone communication line, are located or registered.

The correspondence code may not include a regional code.

If the correspondence code not include a regional code, regional code may constantly or periodically, or temporary consist of or include at least one numeral and/or at least one letter (taken from the alphabet of any language), and/or at least one character (other than a numeral), and/or at least a single space, and/or at least a symbol, and/or at least one hieroglyph, and/or at least one word chosen from any language, and/or a combination of words/an expression (chosen from any speech language), and/or at least one picture, and/or image of geometric figure, and/or at least one geometric figure, and/or at least one digital image, and/or at least one voice message, and/or at least one voice command, and/or at least one animation, and/or at least one animated image, and/or at least one virtual object, and/or at least one 3D virtual object, and/or graphics, and/or computer graphics, and/or at least one video, and/or at least one file icon, and/or at least one file label, and/or at least one computer program icon, and/or at least one computer program label, and/or information (data) in verbal, graphical, sound or combined form, and/or at least one virtual reality object, and/or at least one sound, and/or at least a combination of sounds, and/or at least an electronic program, and/or at least one multimedia file, and/or at least one photo, and/or at least one Internet-link.

If regional code includes at least one element, so at least one auxiliary parameter of at least one mentioned element may be constantly, temporary or periodically taken into account, herewith the said elements includes a numeral, and/or a letter and/or a character, other than a numeral, and/or a symbol, and/or a hieroglyph.

Upon receipt of a telephone call and/or information (message) by the telephone communication line subscriber device, information indicating that the said telephone call was executed and/or the said information (message) was sent using the correspondence code, may appear on the visual display of the said device, herewith the said correspondence code is or is not shown.

In connection with an incoming telephone call or upon receipt of information (message) the calling subscriber's correspondence code and/or the calling subscriber's real telephone number may appear on the visual display of the said subscriber device.

Communication means may take the following aspects into account: a) place of location of the device equipped with a telephone communication line, which has transmitted (has presented) to communication means the correspondence code or information code; and/or b) at least one address transmitted (presented) by the said device.

Communication means may activate the search of information on the basis of information code received (presented), taking into account or without taking into account the place of location of the telephone communication device which has transmitted (has presented) the said information code.

Hieroglyphs included in the correspondence code or information code may belong to: a) the same speech language or b) to different speech languages.

The correspondence code may be attached on temporary or constant or periodical basis.

Communication means may be configured to use telephone line between subscribers: a) without the use of the Internet, b) with the use of the Internet.

The correspondence code may tally with an e-mail address to be used for the purposes of data transmission and receipt, in full or in any part.

Operator of communication means may register correspondence codes.

If a multimedia file is used as the correspondence code, the latter may be formed on the basis of the whole or any part of the said multimedia file.

If the correspondence code or correspondence codes is/are used by the device equipped with a telephone communication line as a telephone number, the said device may have (or not) a telephone number consisting of digits.

Upon receipt of information code tallying with the state registration number of a transport vehicle, in full or in any part, from the calling telephone line subscriber, telephone line operator may connect the calling subscriber with the driver or owner of such transport vehicle.

The calling subscriber may transmit the correspondence code and/or information code to communication means via stationary telephone communication line, or mobile telephone communication, or satellite telephone communication line.

Software and hardware communication means providing for the telephone connections between subscribers, may have the possibility to use telephone line between subscribers without the use of the Internet or with the use of the Internet.

If communication means provide for the telephone communication between telephone line subscribers via the Internet, the correspondence code to be used as a telephone number: a) may not consist of Latin letters (6-32 characters of the same color) only and b) the first letter of a telephone number may not be a Latin letter, should the correspondence code consist of Latin letters and Arabic letters (6-32 characters of the same color).

Telephone communication operator providing for the telephone communication between telephone line subscribers, may be operator of mobile telephone communication and/or stationary telephone communication line and/or satellite telephone communication line.

Infrastructure of the said communication means may include one or more operator of mobile telephone communication and/or stationary telephone communication line and/or satellite telephone communication line.

The correspondence code and/or information code may be transmitted (presented) via telecommunication.

The correspondence code and/or information code may be transmitted (presented) in a discrete form.

The correspondence code may be attached in a discrete form.

When displaying the correspondence code on a visual display: a) may not display at least one part of the said correspondence code, and/or b) may substitute at least a part of the correspondence code with any other information (data).

The correspondence code attached to a telephone line subscriber or a group of telephone line subscribers, or to a device or a group of devices equipped with telephone communication, may represent data related to the state registration number of a transport vehicle or any part thereof, or information related to the place of location of an object, or a postal address, or a data related to a document or any part thereof, or family name, or first name, or father's name, or a nickname, or date of birth, or place of birth, or a photo, or a name of a pet, or a name of an animal, or a name of a bird, or a name of a plant, or a name of a mineral, or a name of a chemical substance, or a name related to branch terminology, or a name of a season, or a name of a month, or a word defining parts of speech, or at least one multimedia file, or a name and/or data related to a legal entity, and/or data related to an organization, or a name of a trade mark, or an abbreviation, or a name of the registered trade mark, or a name of a kind of activity or kinds of activity, or a name of at least one service, or a name of goods, or a name of a product, or a name of an item, or a logo, or a bar-code, or at least one slogan, or a motto, or a proverb, or a saying, or any part thereof, or a name of a song, or lyrics, or part of a poem, or a name of a space object, or a name of a planet, or a name of a part of the world, or a continent, or any part thereof, or a name of geographical objects, or a name of a country, or a state, or a region, or a county, or a city, or a district, or a settlement, or a name of a street, or an area, or a name of a structure, or a name of an educational institution, or a name of an object or objects, or a name of a trade enterprise, or a name of a transport vehicle, or a name of technical means, or a name of a device, or a name of a detail or part of a detail, or a term, or a formula, or a name of profession or professions, or a stylized image of a geometric figure, and/or at least one electronic program, or any combination thereof.

Photo image or any part of a telephone communication subscriber's photo image may be the correspondence code.

### EMBODIMENT OF THE INVENTION

The claimed technical solution is applicable as there are software and hardware means allowing realizing the claimed method for implementing telephone communication with a telephone communication subscriber.

Essential features of the invention specified in section “DESCRIPTION OF THE INVENTION” as an alternative for any choice allowed by the said alternative, together with other features characterizing the invention, provide for the achievement of one and the same technical result being the extension of opportunities connected with the selection of codes corresponding to telephone numbers of called telephone communication subscribers, and optimization of communication between subscribers via the use of correspondence codes and information codes. Opportunity of achievement of the said technical result in case of various combinations of specific characteristics of alternative features of the invention is proved by numerous examples given below:

### Example 1

Telephone communication subscriber may be called up not only by entering to the device equipped with a telephone communication a telephone number consisting of numerals, attached to the telephone communication subscriber, but also by entering to the said device of the correspondence code of the call receiving subscriber's telephone number, which: a) constantly or temporary or periodically consists of or includes at least one letter (taken from the alphabet of any language), and/or at least one character (other than a numeral), and/or at least a single space, and/or at least one symbol, and/or at least one hieroglyph, and/or at least one word chosen from any language, and/or an expression (chosen from any speech language), and/or at least one picture, and/or image of geometric figure, and/or at least one geometric figure, and/or at least one voice message, and/or at least one voice command, and/or at least one animation, and/or at least one animated image, and/or at least one virtual object, and/or at least one virtual 3D object, and/or graphical image, and/or computer graphics, and/or at least one video, and/or at least one file icon, and/or at least one file label, and/or at least one computer program icon, and/or at least one computer program label, and/or information (data) in verbal, graphical, sound or combined form, and/or at least one virtual reality object, and/or at least one sound, and/or at least a combination of sounds, and/or at least an electronic program, and/or at least one multimedia file, and/or at least one photo, and/or at least one Internet-link; or b) constantly or temporary or periodically consists of or includes items mentioned in sub-paragraph “a” in combination with at least one numeral; or c) consists of at least one numeral, herewith the color of at least one numeral of all mentioned numerals, and/or the color of at least a part of at least one numeral of all mentioned numerals, and/or the size of at least one numeral of all mentioned numerals, and/or the type of at least one numeral of all mentioned numerals is\are constantly or temporary or periodically taken into account; d) temporary or periodically includes at least one numeral, or e) constantly or temporary or periodically consists of or includes items mentioned in sub-paragraph “a” in combination with at least one numeral, herewith the color of at least one numeral of all mentioned numerals, and/or the color of at least a part of at least one numeral of all mentioned numerals, and/or the size of at least one numeral of all mentioned numerals, and/or the type of at least one numeral of all mentioned numerals, are constantly or temporary or periodically taken into account; f) temporary or periodically includes at least one numeral, herewith the color of at least one numeral of all mentioned numerals, and/or the color of at least a part of at least one numeral of all mentioned numerals, and/or the size of at least one numeral of all mentioned numerals, and/or the type of at least one numeral of all mentioned numerals, are constantly, temporary or periodically taken into account.

### Example 2

The correspondence code used as a telephone number consists of or includes: a) at least one letter (taken from the alphabet of any language), and/or at least one character (other than a numeral), and/or at least a single space, and/or at least one symbol, and/or at least one hieroglyph, and/or at least one word chosen from any language, and/or an expression (chosen from any speech language), and/or at least one picture, and/or image of geometric figure, and/or computer graphics, and/or animation, and/or animated image, and/or at least one voice message, and/or at least one voice command, and/or at least one sound, and/or at least a combination of sounds, and/or at least one electronic program, and/or at least one multimedia file, and/or at least one photo, and/or at least one Internet-link; or b) items mentioned in sub-paragraph “a” in combination with at least one numeral.

### Example 3

The correspondence code attached to a telephone communication subscriber or a group of telephone communication subscribers, or to a device or a group of devices equipped with telephone communication, represents or includes: data related to the state registration number of a transport vehicle or any part thereof, or information related to the place of location of the object, or a postal address, or a data related to a document or any part thereof, or family name, first name, father's name, or a nickname, or a date of birth, or a place of birth, or a photo, or a name of a pet, or a name of an animal, or a name of a bird, or a name of a plant, or a name of a mineral, or a name of a chemical substance, or a name related to branch terminology, or a name of a season, or a name of a month, or a word defining parts of speech, or at least one multimedia file, or a name and/or a data related to a legal entity, and/or data related to an organization, or a name of a trade mark, or an abbreviation, or a name of the registered trade mark, or a name of a kind of activity or kinds of activity, or a name of at least one service, or a name of goods, or a name of a product, or a name of an item, or a logo, or a bar-code, or at least one slogan, or a motto, or a proverb, or a saying, or any part thereof, or name of a song, or lyrics, or a part of a poem, or name of a space object, or a name of a planet, or a name of a part of the world, or a continent or any part thereof, or a name of geographical objects, or name of a country, or a state, or a region of a county, or a city, or a district, or a settlement, or a name of a street, or an area, or a name of a structure, or a name of an educational institution, or a name of an object or objects, or a name of a trade enterprise, or a name of a transport vehicle, or a name of technical means, or a name of a device, or a name of a detail, or a part of a detail, or a term, or a formula, or a name of profession or professions, or a stylized image of a geometric figure, and/or at least one electronic program, or any combination thereof.

### Example 4

Telephone communication subscriber may be called up by entering to the electronic device of a family name, first name and father's name of the call receiving subscriber, or the state registration number of the transport vehicle belonging to the telephone communication subscriber, or a photo of the call receiving subscriber. The correspondence code may be entered using any speech language. In connection with a telephone call, information showing that the connection is executed by dialing of the correspondence code, appears on the visual display of the call receiving subscriber's telephone communication device.

### Example 5

Should a company have attached own name to one or more telephone numbers as the correspondence code, telephone communication operator connects the calling subscriber with one of the defined telephone numbers of the company by entering the said name of the company to the electronic device equipped with a telephone communication, herewith telephone communication operator could take a place of location of the calling subscriber into account and would connect the said subscriber with the nearest office (address) of the said company. The company may attach one or more correspondence codes to own name. In addition, the company may not have telephone numbers at all when having correspondence codes only.

### Example 6

Telephone communication subscriber may not have a telephone number at all. One or more correspondence codes may be attached to the said telephone communication subscriber only. Should the said subscriber want someone to call him he shall give his correspondence code to the calling subscriber, for example, [symbol] William Smith [symbol] or [symbol] Smith [symbol] , or [symbol] Bill [symbol] or [symbol] Bill 30 [symbol] , or [symbol] W.Smith [symbol] etc.

### Example 7

A calling subscriber may enter the correspondence code attached to the group of telephone numbers, to own device equipped with telephone communication. Herewith one or more different correspondence codes are attached to the said group of telephone numbers of the call receiving subscriber.

### Example 8

A calling subscriber enters the correspondence code to own device equipped with a telephone communication, and transmits information to the call receiving telephone communication subscriber after the connection; or a calling subscriber receives information from a telephone communication subscriber in the form of a voice or verbal, or any other message, instead of a telephone contact with a call receiving subscriber. In case of establishing of connection with a group of subscribers having the same correspondence code, a calling subscriber transmits information to all subscribers within the group having the same correspondence code.

### Example 9

By entering the correspondence code a calling subscriber may make a call to the device equipped with a telephone communication, which is not attached to a certain telephone communication subscriber, for example, a public telephone (installed in public place meant for the use of any person willing so). Herewith the said public telephone could have a separate telephone number or the correspondence code only, for example, “public telephone, railway station, 1^{st} floor” (this means that the said public telephone is located on the 1^{st} floor of the railway station). In addition, a calling subscriber may make a call to a group of devices equipped with a telephone line, not attached to a certain telephone line subscriber.

### Example 10

When entering the correspondence code one may use various colors of the symbols included in the correspondence code. For example, the correspondence code “Ivanov” in black letters corresponds to the correspondence code of the neighbor; the correspondence code “Ivanov” in red letters corresponds to the correspondence code of the manager of the telephone line subscriber; the correspondence code “Ivanov” in green letters corresponds to the correspondence code of the telephone line subscriber's friend. Herewith the telephone communication subscriber to whom the said correspondence code was attached defines the color of the correspondence code.

### Example 11

A multimedia file, for example, the telephone communication subscriber's photo, or image of any symbol (for example, a stylized red heart) etc. may be the correspondence code.

### Example 12

The correspondence code consisting of both letters and numerals may be entered into a telephone line device by the calling subscriber's voice.

### Example 13

The correspondence code may correspond to a telephone communication subscriber's e-mail address.

### Example 14

Letters and words of which the correspondence code consists may be taken from various languages, (for example, [symbol] or [symbol] or Pocpatent).

### Example 15

Should the correspondence code includes at least one object, the color at least of one of the mentioned objects, and/or the color of at least one part of at least one of the mentioned objects, and/or the size of at least one of the mentioned objects, and/or the type of at least one of the mentioned objects are constantly or temporary or periodically taken into account, herewith a letter and/or a character (other than a numeral), and/or a symbol, and/or a hieroglyph, and/or a geometric figure, and/or a virtual object are attributed to the mentioned objects.

### Example 16

When entering a telephone number or the correspondence code of the telephone communication subscriber situated in other region, one may use a regional code. The following may be used as a regional code: name of the region or the abbreviation, defining the region, or at least one numeral defining the region, or at least one conventional symbol defining the region, or at least one symbol defining the region, or at least one geometric figure defining the region, or at least a multimedia file defining the region. For example, regional code of New-York may be given as [symbol] NY [symbol] or as an image of the Statue of Liberty.

### Example 17

Information code consists of or includes constantly or periodically or temporary at least one numeral and/or at least one letter (taken from the alphabet of any language), and/or at least one character (other than a numeral), and/or at least a single space, and/or at least a symbol, and/or at least one hieroglyph, and/or at least one word chosen from any language, and/or a combination of words/an expression (chosen from any speech language), and/or at least one picture, and/or image of geometric figure, and/or at least one geometric figure, and/or at least one voice message, and/or at least one voice command, and/or at least one animation, and/or at least one animated image, and/or at least one virtual object, and/or at least one 3D virtual object, and/or computer graphics, and/or at least one video, and/or at least one file icon, and/or at least one file label, and/or at least one computer program icon, and/or at least one computer program label, and/or information (data) in verbal, graphical, sound or combined form, and/or at least one virtual reality object, and/or at least one sound, and/or at least a combination of sounds, and/or at least an electronic program, and/or at least one multimedia file, and/or at least one photo, and/or at least one Internet-link.

### Example 18

Should the correspondence code includes at least one element, so at least one auxiliary parameter of at least one mentioned element are constantly or temporary or periodically taken into account, herewith the said elements include a letter and/or a character, other than a numeral, and/or a symbol, and/or a hieroglyph, and/or a geometric figure.

### Example 19

Should information code includes at least one element, so at least one auxiliary parameter of at least one mentioned element are constantly or temporary or periodically taken into account, herewith the said elements include a numeral, and/or a letter and/or a character, other than a numeral, and/or a symbol, and/or a hieroglyph.

### Example 20

Use of information code (variant 1). Upon receipt from a calling telephone communication subscriber of the code not corresponding to any correspondence code nor telephone numbers, telephone communication operator performs the actions stipulated by the content of the said information code (or any part thereof), including, for example, the search of telephone number, or the correspondence code, or e-mail address, or place of location of the telephone communication subscriber, other information related to the information code in the Internet, and transmits data received as a result of the said searches, to the calling subscriber. Proceeding from the results of the said searches the calling subscriber may contact a corresponding telephone communication subscriber by phone, or use information received from the telephone communication operator. For example, by entering the code <<Bill Smith Brooklyn>> into own telephone communication device, calling subscriber send such code to the telephone communication operator, who in turn on having failed to find the correspondence code corresponding to that received from the calling subscriber, seeks for alternative variants in various data bases, including at the Internet. The search resulted in the following: telephone communication operator found some persons who corresponded to the requested data, but had different patronymics; found some e-mail addresses attached to persons resided in Brooklyn (corresponded to the requested data “Bill Smith”). Then telephone communication operator sends the results of the search to the calling telephone communication subscriber, who makes a decision about how the information received from the telephone communication operator could be disposed of.

### Example 21

Use of information code (variant 2). Upon receipt from a calling telephone communication subscriber of the code not corresponding to any correspondence code nor telephone numbers, telephone line operator performs the actions stipulated by the content of the said information code (or any part thereof). For example, the calling subscriber enters “Thailand rest January” into own telephone communication device and makes a call. On having received the said code and having failed to find the correspondence codes corresponding to the said code, telephone communication operator seeks for alternative variants at the Internet. As a result of such search the operator found 10 (or 20, or 30) most suitable corresponding alternative variants. Information materials of travel agencies, offering services for the organization of trips in Thailand in January were such suitable corresponding alternative variants. Operator sends information containing telephone numbers or correspondence codes of the said travel agencies, or addresses of offices of the said travel agencies, to the calling subscriber. Then the calling subscriber makes an independent about how the information received from the telephone communication operator could be disposed of.

### Example 22

Use of information code (variant 3). On having received from a calling telephone communication subscriber of the code “flowers shop” having failed to find the correspondence codes corresponding to the said code, telephone communication operator seeks for alternative variants at the Internet and other data bases in consideration of the place of location of the calling subscriber. The telephone communication operator provides the calling subscriber with the information about addresses of flower shops located near to the place of location of the calling subscriber, as well as other contact information of such shops (telephone number, correspondence code, working hours etc.) received as a result of the said searches.

### APPLICATION OF THE INVENTION

The invention may be applied in telephone communication devices for the purposes of telephone calls of a telephone communication subscriber.

1. A method for implementing a telephone communication with a telephone communication subscriber, wherein:
(1) on having received a code (hereinafter referred to as the “correspondence code”), transmitted (presented) to the communication means by a device equipped with a telephone communication (hereinafter the said device referred to as the “calling device”), communication means perform actions including the following steps: telephone call to a telephone communication subscriber (hereinafter referred to as the “call receiving subscriber”) via the call receiving subscriber's subscriber device, and/or data (message) transmission received by the communication means from the calling device to the call receiving subscriber's subscriber device, and/or data (message) transmission received by the communication means from the call receiving subscriber's subscriber device to the calling device, and/or transmission to the calling device of data (message) connected with the call receiving subscriber and/or with the call receiving subscriber's subscriber device, and/or transmission of data (message) connected with the user of the calling device and/or with the calling device to the call receiving subscriber's subscriber device, herewith the correspondence code is attached to:
(a) the call receiving subscriber's telephone number, herewith the correspondence code is other than the call receiving subscriber's telephone number; herewith one correspondence code or more than one dissimilar correspondence codes is/are attached to the call receiving subscriber's telephone number,
or
(b) a group of the call receiving subscriber's telephone numbers, herewith the correspondence code is other than the call receiving subscriber's telephone numbers, herewith one correspondence code or more than one dissimilar correspondence codes is/are attached to a group of the call receiving subscriber's telephone numbers,
or
(c) the call receiving subscriber, herewith the correspondence code is other than the call receiving subscriber's telephone numbers; herewith one correspondence code or more than one dissimilar correspondence codes is/are attached to the call receiving subscriber,
or
(d) the call receiving subscriber as the call receiving subscriber's telephone number, herewith one correspondence code or more than one dissimilar correspondence codes is/are attached to the call receiving subscriber as a telephone number;
herewith, as concern to sub-paragraphs “a”, “b”, “c”, “d”, the correspondence code is attached by communication means or via communication means or without using such communication means;
or
(2) on having received the correspondence code, transmitted (presented) to the communication means by the calling device, communication means perform actions including the following steps: telephone call to a group of telephone communication subscribers (such group is hereinafter referred to as the “group of call receiving subscribers”) via the subscriber device (devices) of the group of call receiving subscribers, and/or data (message) transmission received by the communication means from the calling device to the subscriber device (devices) of the group of call receiving subscribers, and/or data (message) transmission received by the communication means from subscriber device (devices) of the group of telephone communication subscribers to the calling device, and/or transmission to the calling device data (message) connected with the group of call receiving subscribers and/or with the subscriber device (devices) of the group of call receiving subscribers, and/or transmission of data (message) connected with the user of the calling device and/or with the calling device, to the subscriber device (devices) of the group of call receiving subscribers, herewith the correspondence code is attached to:
(a) the telephone number (numbers) of the group of call receiving subscribers, herewith the correspondence code is other than the telephone numbers of the group of call receiving subscribers,
and/or
(b) the subscribers within the group of the call receiving subscribers,
or
(c) the group of call receiving subscribers as the telephone number of the group of call receiving subscribers, herewith one correspondence code or more than one dissimilar correspondence codes is/are attached to the group of call receiving subscribers as a telephone number,
herewith, as concern to sub-paragraphs “a”, “b”, “c”, the correspondence code is attached by communication means or via communication means or without using such communication means;
or
(3) on having received the correspondence code transmitted (presented) to the communication means by the calling device, communication means perform actions including the following steps: telephone call to the device equipped with telephone communication (such device is hereinafter referred to as the “call receiving device”); and/or data (message) transmission received by the communication means from the calling device to the call receiving device, and/or data (message) transmission received by the communication means from the call receiving device to the calling device; and/or transmission of data (message) connected with the call receiving device to the calling device; and/or transmission of data (message) connected with the user of the calling device and/or with the calling device to the call receiving device, herewith the correspondence code is attached to:
(a) the telephone number of the call receiving device, herewith the correspondence code is other than a telephone number of the call receiving device; herewith one correspondence code or more than one dissimilar correspondence codes is/are attached to the telephone number of the call receiving device,
or
(b) the call receiving device as a telephone number of the call receiving device, herewith one correspondence code or more than one dissimilar correspondence codes is/are attached to the call receiving device as a telephone number,
herewith as concern to sub-paragraphs “a”, “b”, the correspondence code is attached by communication means or via communication means or without using such communication means;
or
(4) on having received the correspondence code transmitted (presented) to the communication means by the calling device, communication means perform actions including the following steps: telephone call to the group of devices equipped with a telephone communication (such group is hereinafter referred to as the “group of call receiving devices”), and/or data transmission received by the communication means from the calling device to the group of call receiving devices, and/or data (message) transmission received by the communication means from the group of call receiving devices to the calling device, and/or transmission of data (message) connected with the group of call receiving devices to the calling device, and/or transmission of data (message) connected with the user of the calling device and/or with the calling device to the group of call receiving devices, herewith the correspondence code is attached to:
(a) telephone number (numbers) of the group of call receiving devices, herewith the correspondence code is other than telephone numbers of the group of call receiving devices; herewith one correspondence code or more than one dissimilar correspondence codes is/are attached to the telephone numbers of the group of call receiving devices;
or
(b) the group of call receiving devices as a telephone number of the group of call receiving devices, herewith one correspondence code or more than one dissimilar correspondence codes is/are attached to the group of call receiving devices as a telephone number,
herewith, as concern to sub-paragraphs “a”, “b”, the correspondence code is attached by communication means or via communication means or without using such communication means;
or
(5) when a code which does not correspond to any correspondence code nor to the telephone number (such code not corresponding to any correspondence code nor to the telephone number, is hereinafter referred to as the “information code”) is received from the calling telephone communication subscriber, communication means perform actions stipulated by the content (sense) of the said information code, or any part thereof, via own software and hardware and/or via software and hardware of at least one other device connected to the communication means, whether with or without the use of Internet, including the following steps:
(a) search of a telephone number (numbers) and/or a correspondence code (codes) of the telephone communication subscriber or device equipped with the telephone communication, or a telephone numbers and/or a correspondence codes of telephone communication subscribers or devices equipped with the telephone communication, and/or telephone number or telephone numbers and/or correspondence code or correspondence codes of the group of telephone communication subscribers or group of devices equipped with the telephone communication, and/or telephone numbers and/or correspondence codes of groups of telephone communication subscribers or groups of devices equipped with the telephone communication and transmission of data received as a result of the above search to the calling subscriber;
and/or
(b) search of an e-mail address (e-mail addresses) of the subscriber or subscribers or the group of telephone communication subscribers or groups of telephone communication subscribers, and/or a device (devices) equipped with the telephone communication, and/or the group of devices or groups of devices equipped with the telephone communication; and/or any third person (persons) and transmission of data received as a result of the above search to the calling subscriber;
and/or
(c) search of the place of location of the subscriber or subscribers or the group of telephone communication subscribers, and/or a device or group of devices equipped with the telephone communication, and/or any third person (persons), and transmission of data received as a result of the above search to the calling subscriber;
and/or
(d) search of the address or addresses of the subscriber or subscribers or the group of telephone communication subscribers or groups of telephone communication subscribers, and/or a device (devices) equipped with the telephone communication, and/or the group of devices or groups of devices equipped with the telephone communication, and/or any third person (persons) and transmission of data received as a result of the above search to the calling subscriber;
and/or
(e) search of information in the Internet using the information code and transmission of data received as a result of the above search to the calling subscriber;
and/or
(f) connecting the calling subscriber with the telephone communication subscriber or with group of telephone communication subscribers or with a device or group of devices equipped with telephone communication or with any third person (persons) in consideration of data received as a result of the above search;
and/or
(g) transmission of data received from the telephone communication subscriber or group of telephone communication subscribers or from a device or group of devices equipped with telephone communication or from any third person (persons) to the calling subscriber in consideration of data received as a result of the above search;
herewith:
the correspondence code specified in sub-paragraphs “a”, “b”, “c” of paragraph (1), in sub-paragraphs “a”, “b” of paragraph (2), in sub-paragraph “a” of paragraph (3), in sub-paragraph “a” of paragraph (4): a) constantly or periodically or temporary consists of or constantly or periodically or temporary includes at least one letter (taken from the alphabet of any language), and/or at least one character (other than a numeral), and/or at least a single space, and/or at least one symbol, and/or at least one hieroglyph, and/or at least one word chosen from any language, and/or an expression (chosen from any speech language), and/or at least one picture and/or image of geometric figure, and/or at least one geometric figure, and/or at least one digital image, and/or at least one voice message, and/or at least one voice command, and/or at least one animation, and/or at least one animated image, and/or at least one virtual object, and/or at least one virtual 3D object, and/or graphical image, and/or computer graphics, and/or at least one video, and/or at least one file icon, and/or at least one file label, and/or at least one computer program icon, and/or at least one computer program label, and/or at least one digital image, and/or information (data) in verbal, graphical, sound or combined form, and/or at least one virtual reality object, and/or at least one sound, and/or at least a combination of sounds, and/or at least an electronic program, and/or at least one multimedia file, and/or at least one photo, and/or at least one Internet-link, or b) constantly or periodically or temporary includes items mentioned in the above sub-paragraph “a” and one or more numerals, or c) constantly or periodically or temporary includes items mentioned in the above sub-paragraph “a” and one or more numerals, herewith at least one auxiliary parameter of at least one of the mentioned numerals are taken into account, or d) constantly or periodically or temporary includes items mentioned in the above sub-paragraph “a”, herewith the correspondence code constantly or periodically or temporary includes at least one numeral, or e) constantly or periodically or temporary includes items mentioned in the above sub-paragraph “a”, herewith the correspondence code constantly or periodically or temporary includes at least one numeral, herewith if the correspondence code includes at least one numeral, at least one auxiliary parameter of at least one of the mentioned numerals are taken into account, or f) constantly or periodically or temporary consists of or constantly or periodically or temporary includes one or more numerals, herewith at least one auxiliary parameter of at least one of the mentioned numerals are taken into account, or g) constantly or periodically or temporary consists of or constantly or periodically or temporary includes one or more numerals, herewith the correspondence code constantly or periodically or temporary includes items mentioned in the above sub-paragraph “a”, or h) constantly or periodically or temporary consists of or constantly or periodically or temporary includes one or more numerals, herewith the correspondence code temporary or periodically includes items mentioned in the above sub-paragraph “a”, herewith at least one auxiliary parameter of at least one of the mentioned numerals are taken into account, or i) temporary or periodically includes a numeral or numerals, or j) temporary or periodically includes a numeral or numerals, herewith if the correspondence code includes at least one numeral, so at least one auxiliary parameter of at least one of the mentioned numerals are taken into account;
the correspondence code specified in sub-paragraph “d” of paragraph (1), in sub-paragraph “c” of paragraph (2), in sub-paragraph “b” of paragraph (3), in sub-paragraph “b” of paragraph (4) to be used as a telephone number consists of or includes: a) at least one letter (taken from the alphabet of any language), and/or at least one character (other than a numeral), and/or at least a single space, and/or at least a symbol, and/or at least one hieroglyph, and/or at least one word chosen from any language, and/or a combination of words/an expression (chosen from any speech language), and/or at least one picture and/or image of geometric figure, and/or computer graphics, and/or at least one digital image, and/or animation and/or animated image, and/or at least one voice message, and/or at least one voice command, and/or at least one sound and/or at least a combination of sounds, and/or at least an electronic program, and/or at least one multimedia file, and/or one photo, and/or at least one Internet-link, or b) the items mentioned in sub-paragraph “a” in combination with at least one numeral.

2. The method according to claim 1, wherein if the correspondence code mentioned in sub-paragraphs “a”, “b”, “c” of paragraph (1), in sub-paragraphs “a” and “b” of paragraph (2), in sub-paragraph “a” of paragraph (3), in sub-paragraph “a” of paragraph (4) includes at least one element, so at least one auxiliary parameter of at least one mentioned element are constantly, temporary or periodically taken into account, herewith the said elements include a letter and/or a character, other than a numeral, and/or a symbol, and/or a hieroglyph, and/or a geometric figure.

3. The method according to claim 1, wherein information code constantly or periodically or temporary consists of or includes at least one numeral and/or at least one letter (taken from the alphabet of any language), and/or at least one character (other than a numeral), and/or at least a single space, and/or at least a symbol, and/or at least one hieroglyph, and/or at least one word chosen from any language, and/or a combination of words/an expression (chosen from any speech language), and/or at least one picture, and/or image of geometric figure, and/or at least one geometric figure, and/or at least one voice message, and/or at least one voice command, and/or at least one animation, and/or at least one animated image, and/or at least one virtual object, and/or at least one 3D virtual object, and/or graphics, and/or computer graphics, and/or at least one video, and/or at least one file icon, and/or at least one file label, and/or at least one computer program icon, and/or at least one computer program label, and/or information (data) in verbal, graphical, sound or combined form, and/or at least one virtual reality object, and/or at least one sound, and/or at least a combination of sounds, and/or at least an electronic program, and/or at least one multimedia file, and/or at least one photo, and/or at least one Internet-link.

4. The method according to claim 1, wherein if information code includes at least one element, so at least one auxiliary parameter of at least one mentioned element is constantly, temporary or periodically taken into account, herewith the said elements include a numeral, and/or a letter, and/or a character other than a numeral, and/or a symbol, and/or a hieroglyph.

5. The method according to the claim 1, wherein the correspondence code and/or information code is entered into the device equipped with a telephone communication, and/or into the device connected to the device equipped with a telephone communication, in writing and/or in the form of a text, and/or by voice as is applicable.

6. The method according to claim 1, wherein the correspondence code and/or information code is entered into the device equipped with a telephone communication, and/or device connected to the device equipped with a telephone communication when dialing the telephone number, as is applicable.

7. The method according to claim 1, wherein the correspondence code includes a regional code defining a region in which the call receiving subscriber or group of call receiving subscribers, or call receiving device equipped with a telephone communication, or the group of call receiving devices equipped with a telephone communication, are located or registered.

8. (canceled)

9. The method according to claim 7, wherein the regional code constantly or periodically, or temporary consist of or includes at least one numeral, and/or at least one letter (taken from the alphabet of any language), and/or at least one character (other than a numeral), and/or at least a single space, and/or at least a symbol, and/or at least one hieroglyph, and/or at least one word chosen from any language, and/or a combination of words/an expression (chosen from any speech language), and/or at least one picture, and/or image of geometric figure, and/or at least one geometric figure, and/or at least one digital image, and/or at least one voice message, and/or at least one voice command, and/or at least one animation, and/or at least one animated image, and/or at least one virtual object, and/or at least one 3D virtual object, and/or graphics, and/or computer graphics, and/or at least one video, and/or at least one file icon, and/or at least one file label, and/or at least one computer program icon, and/or at least one computer program label, and/or information (data) in verbal, graphical, sound or combined form, and/or at least one virtual reality object, and/or at least one sound, and/or at least a combination of sounds, and/or at least an electronic program, and/or at least one multimedia file, and/or at least one photo, and/or at least one Internet-link.

10. The method according to claim 9, wherein if the correspondence code includes at least one element, so at least one auxiliary parameter of at least one mentioned element are constantly or temporary or periodically taken into account, herewith the said elements include a numeral, and/or a letter and/or a character other than a numeral, and/or a symbol, and/or a hieroglyph.

11. The method according to claim 1, wherein upon receipt of a telephone call and/or information (message) by the telephone communication subscriber device, information indicating that the said telephone call was executed and/or the said information (message) was sent using the correspondence code, appears on the visual display of the said device, herewith the said correspondence code is shown or is not shown.

12. The method according to claim 1, wherein in connection with an incoming telephone call or upon receipt of information (message) the calling subscriber's correspondence code and/or the calling subscriber's real telephone number appear(s) on the visual display of the said subscriber device.

13. The method according to claim 1, wherein communication means take into account: a) place of location of the device equipped with a telephone communication, which has transmitted (presented) to the communication means the correspondence code or information code, and/or b) at least one address transmitted (presented) by the said device.

14. The method according to claim 1, wherein communication means activate the search of information on the basis of information code received (presented), taking or without taking into account the place of location of the telephone communication device which has transmitted (presented) the said information code.

15-23. (canceled)

24. The method according to claim 1, wherein at displaying the correspondence code on a visual display: a) it is not displayed at least one part of the said correspondence code, and/or b) it is substituted at least one part of the correspondence code with any other information (data).
